(19) United States
(12) Patent Application Publication
(10) Pub. No.: US 2025/0019251 A1
(43) Pub. Date: Jan. 16, 2025

(54) METHOD FOR OPERATING AN AMMONIA PLANT, AND PLANT FOR PRODUCING AMMONIA

(71) Applicants: thyssenkrupp Uhde GmbH, Dortmund (DE); thyssenkrupp AG, Essen (DE)

(72) Inventors: Bernd MIELKE, Witten (DE); Klaus NOELKER, Dortmund (DE); Dirk MEURER, Dortmund (DE); Tobias BIRWE, Dortmund (DE); Bernd KEIL, Dortmund (DE); Johannes ELISCHEWSKI, Dortmund (DE); Markus TIEGS, Dortmund (DE)

(73) Assignees: thyssenkrupp Uhde GmbH, Dortmund (DE); thyssenkrupp AG, Essen (DE)

(21) Appl. No.: 18/715,658

(22) PCT Filed: Dec. 2, 2022
(86) PCT No.: PCT/EP2022/084224

§ 371 Date: May 31, 2024

(30) Foreign Application Priority Data
Dec. 3, 2021 (BE) BE 2021/5940
Dec. 3, 2021 (BE) BE 2021/5941
Dec. 3, 2021 (DE) 10 2021 213 799.7
Dec. 3, 2021 (DE) 10 2021 213 800.4

(51) Int. Cl. C01C 1/04; B01D 53/00; B01J 8/00; B01J 8/06; C25B 15/08

(52) U.S. Cl. CPC C01C 1/0441; B01D 53/002; B01J 8/001; B01J 8/065; B01J 8/067; C01C 1/047; C01C 1/0482; C25B 15/081; B01D 2257/406; B01J 2208/00548; B01J 2208/065

(57) ABSTRACT

In a process for operating an ammonia plant, a gas mixture comprising nitrogen, hydrogen and ammonia is conveyed cyclically in a synthesis circuit with a conveying device which comprises at least a first compressor, nitrogen and hydrogen are converted at least partly into ammonia in a converter, the gas mixture is cooled in a cooling device in such a way that ammonia condenses out of the gas mixture, and hydrogen is provided at least partly by electrolysis. In this process, the utilization of fluctuating renewable energies can be integrated into existing plant designs, for the provision of hydrogen; for this reason, a master controller is provided and the master controller keeps at least the pressure in the synthesis circuit approximately constant via at least one control loop, on the basis of the anticipated amount of hydrogen. For this, the apparatus comprises a first bypass line for circumventing the first compressor, and a second bypass line for circumventing the cooling device.

The invention relates to a process for operating an ammonia plant, wherein a gas mixture comprising nitrogen, hydrogen and ammonia is conveyed cyclically in a synthesis circuit with a conveying device, wherein nitrogen and hydrogen are converted at least partly into ammonia in a converter, wherein the gas mixture is cooled in a cooling device in such a way that ammonia condenses out of the gas mixture, wherein hydrogen is provided at least partly by electrolysis, and wherein the conveying device comprises at least a first compressor having a first suction side and a first pressure side.

In addition, the invention relates to a plant for producing ammonia in a synthesis circuit, having at least one conveying device for cyclically conveying a gas mixture comprising nitrogen, hydrogen and ammonia, having at least one converter, wherein nitrogen and hydrogen can be converted at least partly into ammonia in the converter, and having at least one cooling device in which the gas mixture can be cooled in such a way that ammonia condenses out of the gas mixture, wherein hydrogen can be provided at least partly by an electrolyzer and wherein at least one bypass line is provided to circumvent at least one unit of the synthesis circuit, wherein the flow rate in the bypass line can be established by at least one flow control valve, wherein a master controller is provided, wherein the at least one flow control valve can be regulated by the master controller.

Further, the invention relates to a process for retrofitting a plant for producing ammonia.

Ammonia is one of the most important commodities. Annual world production is currently about 170 million tonnes. The majority of the ammonia is used for production of fertilizers. Industrial-scale production nowadays uses mainly the high-pressure synthesis developed by Haber and Bosch at the start of the 20th century, in fixed bed reactors with iron as catalytically active main component, based on a synthesis gas of stoichiometric composition with hydrogen and nitrogen as its main components. The synthesis gas is generated predominantly via the natural gas route. A disadvantage here are the large amounts of carbon dioxide obtained.

The exothermic character of the ammonia formation reaction gives rise to relatively large amounts of heat in the course of the process. For good specific energy consumption of the overall process, these amounts of heat must be utilized with maximum efficiency. In general, utilization of waste heat is associated with thermodynamically unavoidable losses. There has therefore been no lack of attempts to develop alternatives to the Haber-Bosch process that operate without the high temperatures and pressures. In the Haber-Bosch process, the fundamental difficulty of activating the very unreactive nitrogen molecule is overcome by the use of specifically very active catalysts in combination with relatively high temperatures. An alternative for the provision of the activation energy required is the use of electrical energy.

In order to save carbon dioxide, considerations are given to obtaining the raw materials, especially hydrogen, not, or not completely, via the natural gas route. EP 2 589 426 A1 discloses, for example, a process for producing ammonia in which hydrogen is obtained from the electrolysis of water. Nitrogen can be obtained, for example, from a cryogenic air separation plant. The substances are mixed with one another and compressed to a pressure in the range from 80 to 300 bar.

The problem here is that renewable energies such as wind or solar may fluctuate sharply. The electrolyzer (the electrolysis apparatus) is able to follow these fluctuations quickly and also in a wide load range extending to a partial load of 10%. The ammonia plant then receives a reduced stream of hydrogen, necessitating a complex control intervention in order to put the ammonia plant into a partial-load operation, without damaging machinery and apparatus, and to ensure uninterrupted production of ammonia.

It is therefore an object of the invention to specify a process for operating an ammonia plant, and also a plant for producing ammonia, wherein the utilization of fluctuating renewable energies for the provision of hydrogen can be integrated into existing plant designs.

This object is first achieved by the features of claim 1, in that a master controller is provided and in that the pressure in the synthesis circuit is kept approximately constant by the master controller via at least one control loop on the basis of the anticipated amount of hydrogen. Here, a first bypass line is provided from the first pressure side to the first suction side, wherein the master controller dictates the minimum opening of a first flow control valve as a function of an anticipated first suction stream at the first suction side of the first compressor, wherein the first flow control valve establishes at least the flow rate in the first bypass line. Here, the gas mixture is divided ahead of the cooling device into a first substream and a second substream, the first substream is passed through the cooling device, and the second substream is introduced back into the synthesis circuit in a region upstream of the first suction side of the conveying device. Accordingly, the unit of the synthesis circuit that is circumvented with the first bypass line is therefore the first compressor. Additionally, the second substream is cooled before introduction into the synthesis circuit, the master controller dictates the minimum opening of a second flow control valve, and the second flow control valve establishes at least the flow rate of the second substream.

If fluctuating regenerative energies mean that less hydrogen is produced in the alkaline electrolysis of water, the anticipated amount of hydrogen is dictated as an input variable to the master controller (a superordinate control device which performs superordinate control of a multiplicity of specific control loops simultaneously). Measuring the current amount of hydrogen and using this as an input variable for the master controller is not sufficient. In the event of changes in load in the electrolyzer there can be instances of vibration feedback into the power network providing power supply. To avoid this, it is necessary to use uncontrolled filters. Because of this, however, the electrolyzer is unable to provide continuous coverage of the output spectrum of 10-100%, and instead there are discrete values for the output. The electrolyzer is also able to change its load from 100% to 10% in less than one minute, whereas the ammonia plant requires around an hour for a change in load of 25%, owing to the masses of catalyst and apparatuses that require cooling or heating.

The master controller uses the anticipated amount of hydrogen to calculate the turn-down ratio (the ratio of current production capacity to nominal production capacity in %) that is to be established for the ammonia plant. The function of the master controller in this context is to ensure that the pressure in the synthesis gas circuit is kept constant, in order to prevent material fatigue as a result of alternating-pressure stress. Furthermore, the master controller is able to establish the temperature profile in the converter (reactor) such that, where there are a plurality of catalyst beds, the reaction is maintained in all the catalyst beds and the bed exit temperature occurring is not too high, which would cause nitration (nitriding) of the pressure-bearing steel casing in the reactor. Finally, the master controller ensures that the amount of circulation gas does not drop below a defined value, for example 50 percent of the amount when compared to normal operation. When the pressure is being kept constant, it is important that the amount of circulation gas does not become too small, in order, overall, to enable control and to avoid damaging the plant.

In accordance with the process of the invention, therefore, the gas mixture is divided ahead of the cooling device into a first substream and a second substream, the first substream is passed through the cooling device, the second substream is introduced back into the synthesis circuit in a region upstream of the first suction side of the conveying device, and the second substream is cooled before introduction into the synthesis circuit, wherein the master controller dictates the minimum opening of a second flow control valve, wherein the second flow control valve establishes at least the flow rate of the second substream. The unit of the synthesis circuit that is circumvented with the second bypass line is therefore the cooling device. The second substream is therefore introduced back into the synthesis circuit in a region downstream (behind in flow direction) of the cooling device but upstream (ahead) of the first suction side of the conveying device—that is, in the flow direction, between the cooling device and the first suction side.

If the amount of feedstock gas or hydrogen is smaller, the risk exists, where the circulation amount is lower, of the reaction proceeding further in the first catalyst bed, in a converter having multiple catalyst beds. As a result, the exit temperature from the first catalyst bed may become too high, possibly leading to damage to the catalyst and to the pressure-bearing reactor casing. The risk exists, furthermore, that feedstock gas that normally reacts only in the second catalyst bed is already consumed. As a result of this, the second catalyst bed would cool. Because of a longer residence time, the gas also cools in any internal heat exchangers below the light-off temperature for a possible third catalyst bed.

Too high an exit temperature from the first catalyst bed may be avoided by raising the entry concentration of ammonia into the converter. The entry concentration into the converter is normally a product of the temperature at which the ammonia is removed. The ammonia entry concentration could therefore be increased by cooling the circulation gas to less of an extent with the cooling device. That, however, would have the disadvantage of altering the temperature level in all the apparatuses of the cooling device, meaning-if the full amount of hydrogen is available again—that the cooling device would first have to be cooled down again, with a certain time elapsing until the plant is able to run at 100% again. In order to be able to change the concentration rapidly in the event of a required change in load, therefore, a bypass around the cooling device is enabled. The effect of this is that ammonia is condensed only out of a portion of the circulation gas, while an ammonia-rich stream is conveyed past the cooling device via the bypass line and is not cooled. The desired ammonia concentration is then a product of the mixing of the cooled stream and the bypass stream on the first suction side of the conveying device.

Providing a circumvention of the cooling apparatus only for one substream, however, is not enough for stable operation under partial load, since when the position of the second flow control valve is changed, the pressure exhibits an overshoot. The resulting pressure fluctuations end only after a certain bedding-in time. If the position of the second flow control valve is changed, there are changes not only in the volume flow and the temperature of the circulation gas, but also in its composition. As has been discovered, these changes lead to pressure fluctuations, since the reactor output has not adjusted to the parameter of the circulation gas after such a change: if less ammonia is removed from the circulation gas, the molar concentration of ammonia in the circulation gas goes up. With a higher ammonia concentration on entry into a catalyst bed of the converter, less new ammonia is formed, even if hydrogen and nitrogen continue to be fed in, and consequently there is an increase in the pressure in the circulation gas. This decreases the molar concentration of ammonia in the circuit, more ammonia is formed, and the pressure drops, causing the molar fraction of ammonia in the circulation gas to rise again and causing pressure fluctuations. In order to avoid this behavior, circumvention of the cooling device in the sense of the invention can be carried out only together with a further measure:

It is therefore vital in the invention that the conveying device comprises at least a first compressor having a first suction side and a first pressure side; that a first bypass line (circumvention line) is provided from the first pressure side to the first suction side; and that the master controller dictates the minimum opening of a first flow control valve as a function of an anticipated first suction stream at the first suction side of the first compressor, wherein the first flow control valve establishes at least the flow rate in the first bypass line.

If the amount of make-up gas is altered, the pressure in the synthesis gas circuit and the amount of circulation gas would alter without control intervention. The function of the master controller is to keep the pressure in the synthesis gas circuit constant, by adapting the conversion in the converter such that the converter consumes only the amount of hydrogen and nitrogen that can be fed into the synthesis circuit with the make-up gas. Here, the master controller establishes an amount of circulation gas, defined for each load scenario, such that a minimum throughput through the reactor is secured and the conveying device does not enter the surge range: if the intake amount falls below a minimum volume flow rate, the compressor 30 begins to “surge” (“pump”), leading to fluctuating conveying rates and conveying pressures and possibly damaging the machine. In order to prevent this, compressors are generally equipped with an anti-surge controller. Essentially, this is a bypass line from the first pressure side to the first suction side of the compressor, said line being provided with a control valve. By these means, the controller then establishes the suction amount, in the case of a centrifugal compressor, or the suction pressure, in the case of a piston compressor. The conveying device is equipped with an anti-surge controller and with a bypass line with flow control valve. To avoid any alteration of the synthesis pressure, the master controller, which knows the anticipated amount of circulation gas, is able to deploy the anti-surge controller and, for the flow control valve, dictates the minimum opening, until the anti-surge controller of the circulation gas compressor is then able to level out the lower circulation stream. Accordingly, then, an anti-surge controller which the compressor already possesses may be used additionally to counter the pressure fluctuations in the converter as well. This does not correspond to the conventional anti-surge controller, and so the master controller must actively deploy the existing anti-surge controller of the compressor. If such deployment is not possible or is unwanted for other reasons (lack of anti-surge controller, safety aspects, capacity restrictions), then a bypass for the controlled circumvention of the compressor can of course also be realized in a separate line (possibly even in the form of retrofittable elements).

According to one optional configuration of the process of the invention, the second substream is cooled before it is introduced into the synthesis circuit. Overall, the entry temperature into the conveying device must not be too high, since otherwise the conveying device might be damaged by excessive exit temperatures. For this purpose, a portion of the hot bypass stream can be passed on via a water cooler, allowing the temperature at the suction side of the conveying device to be controlled as the mixing temperature of cold circulation gas and partly cooled bypass gas.

In a first configuration of the process of the invention, the amount of hydrogen generated by the electrolysis is measured at the entry into the ammonia plant, and the master controller adapts the capacity of the ammonia plant, taking account of the amount of hydrogen measured. The amount of hydrogen actually generated is measured at the entry into the ammonia plant. If this amount differs from the amount of hydrogen pre-notified from the electrolysis, the master controller adapts the capacity of the ammonia plant to the measured amount.

In a further configuration of the process of the invention, the master controller dictates setpoint values to control elements of the at least one control loop if the change in load to be established is below a predetermined limiting value, and the master controller directly dictates the degree of opening of a control valve of the control loop if the change in load to be established is above a predetermined limiting value. A general rule here is that for relatively small changes in load, the master controller dictates only the setpoint value to the individual controllers. For larger changes in load, or if the output of the plant is to be increased or lowered within a certain time, the master controller also dictates the degree of opening directly for control valves.

In one advantageous configuration of the process of the invention, hydrogen is compressed with at least one second compressor having a second suction side and a second pressure side, a second bypass line is provided from the second pressure side to the second suction side, and the master controller dictates the minimum opening of a third flow control valve as a function of an anticipated second suction stream at the second suction side of the second compressor, wherein the third flow control valve establishes at least the flow rate in the third bypass line.

The second compressor is designed for a defined flow rate. If the intake amount falls below a minimum volume flow rate, the compressor begins to “surge” (“pump”), leading to fluctuating conveying rates and conveying pressures and possibly damaging the machine. In order to prevent this, compressors are generally equipped with an anti-surge controller. To avoid any alteration in the conveying pressure, the master controller, which knows the anticipated suction stream, is able to deploy the anti-surge controller directly and, for the flow control valve, to dictate the minimum opening, until the anti-surge controller is able to level out the lower suction stream.

In a further advantageous configuration of the process of the invention, the heat released from the ammonia reaction is utilized for generating steam in at least one first heat exchanger, a fourth bypass line around the first heat exchanger is provided, and the master controller dictates the minimum opening of a fourth flow control valve, wherein the fourth flow control valve establishes at least the flow rate in the fourth bypass line.

The heat released in the ammonia reaction is utilized to generate steam and to preheat cold circulation gas in a gas/gas heat exchanger. If too much heat is removed from the circuit with the enthalpy of the steam, however, the remaining heat is no longer sufficient to preheat the circulation gas to the catalyst light-off temperature. The amount of steam which can be generated in a partial load scenario is controlled by a bypass around the steam generation, so also controlling the necessary entry temperature of the hot circulation gas into the gas/gas heat exchanger, the first heat exchanger. This takes place by a master controller dictating a setpoint value to the corresponding fourth flow control valve.

In a further configuration of the invention, at least one second heat exchanger is utilized for preheating the gas mixture in the synthesis circuit, a fifth bypass line around the second heat exchanger is provided, and the master controller dictates the minimum opening of a fifth flow control valve as a function of the entry temperature to be established for the gas mixture into the converter, wherein the fifth flow control valve establishes at least the flow rate in the fifth bypass line.

It must be ensured that in the partial load scenario as well, the entry temperature into the catalyst bed is above the light-off temperature of the catalyst, but is also not too high, so that the exit temperature from the first catalyst bed does not exceed the permissible temperature. The entry temperature is a product of the entry temperature into the reactor and of the amounts of heat which in possible internal heat exchangers after possible further catalyst beds, i.e., a first and second catalyst bed, are transferred to the reaction gas. Because the amounts of heat released in the first and second catalyst beds are not amenable to direct monitoring, the entry temperature into the first catalyst bed can be controlled by way of the entry temperature into the converter. For this purpose, a portion of the cold circulation gas is passed via a controlled bypass around the shell side, the cold side, of a gas/gas heat exchanger, the second heat exchanger, and so the entry temperature into the converter is a product of the mixing temperature of cold, bypassed and preheated circulation gas.

In a further configuration of the process of the invention, the converter comprises a first radially flow-traversable catalyst bed, a second radially flow-traversable catalyst bed and a third radially flow-traversable catalyst bed, the converter comprises at least two internal heat exchangers, and the first internal heat exchanger is disposed between the first catalyst bed and the second catalyst bed and the second internal heat exchanger is disposed between the second catalyst bed and the third catalyst bed, a sixth bypass line around the first internal heat exchanger is provided, and the master controller dictates the minimum opening of a sixth flow control valve, wherein the sixth flow control valve establishes at least the flow rate in the sixth bypass line.

It must be ensured that in the partial load scenario as well, the entry temperature into the second catalyst bed is above the light-off temperature of the catalyst, but is also not too high, so that the exit temperature from the second catalyst bed does not exceed the permissible temperature. The entry temperature into the second catalyst bed is determined very greatly by the heat of reaction of the first catalyst bed, which is delivered to the circulation gas in the first internal heat exchanger. The running scenario governing the area of the heat exchanger is the 100% running scenario (current production capacity with a turn-down ratio of 100%), since here the amount of heat to be transferred is six times as great as the amount of heat in the minimum load scenario at 25%. For this scenario, there is a bypass around the first internal heat exchanger, where a portion of the only preheated circulation gas is fed directly onto the first catalyst bed. If the bypass is further open, less only preheated circulation gas flows through the tube side of the first internal heat exchanger and less heat is transferred from the hot reaction gas, leaving the first catalyst bed, to the colder circulation gas, and so the entry temperature into the second catalyst bed goes up. If, conversely, the bypass is closed further, more only preheated circulation gas flows through the tube side of the first internal heat exchanger, and more heat is transferred from the hot reaction gas, leaving the first catalyst bed, to the colder circulation gas, and so the entry temperature into the second catalyst bed goes down. In this context, however, the master controller must prevent the bypass valve being opened too widely and the entry temperature into the first catalyst bed dropping below 370° C.

Additionally, in a further configuration of the process of the invention, a seventh bypass line around the second internal heat exchanger is provided and the master controller dictates the minimum opening of a seventh flow control valve, wherein the seventh flow control valve establishes at least the flow rate in the seventh bypass line.

It must be ensured that in the partial load scenario as well, the entry temperature into the third catalyst bed is above the light-off temperature of the catalyst, but is also not too high, so that the exit temperature from the third catalyst bed does not exceed the permissible temperature. The entry temperature into the third catalyst bed is determined very greatly by the heat of reaction of the second catalyst bed, which is delivered to the circulation gas in the second internal heat exchanger. The running scenario governing the area of the second internal heat exchanger is the minimum running scenario, since here the entry temperature of the circulation gas into the reactor is the highest and hence the logarithmic mean of the temperature difference across the second internal heat exchanger is the smallest. For this scenario, there is a bypass around the second internal heat exchanger, where a portion of the only preheated circulation gas is passed directly to the first internal heat exchanger. If the bypass is further open, less only preheated circulation gas flows through the tube side of the second internal heat exchanger and less heat is transferred from the hot reaction gas, leaving the second catalyst bed, to the colder circulation gas, and so the entry temperature into the third catalyst bed goes up. If, conversely, the bypass is closed further, more only preheated circulation gas flows through the tube side of the second internal heat exchanger, and more heat is transferred from the hot reaction gas, leaving the second catalyst bed, to the colder circulation gas, and so the entry temperature into the third catalyst bed goes down. In this context, however, the master controller must prevent the bypass valve being opened too widely and the entry temperature into the second catalyst bed dropping below 370° C.

The operation described above contains an example of a synthesis gas circuit with an ammonia converter, three radially flow-traversed catalyst beds and two internal heat exchangers. Other possibilities, though, are also conceivable. They include a synthesis circuit consisting of a radially flow-traversed converter with two catalyst beds and an internal heat exchanger, a waste heat tank, a radially flow-traversed one-bed converter without internal heat exchanger, and a waste heat tank with internal tank feed water preheating. Likewise conceivable is a synthesis circuit consisting of a first radially flow-traversed converter with two catalyst beds and an internal heat exchanger, a steam superheater, a waste heat tank, a second radially flow-traversed converter with two catalyst beds and an internal heat exchanger, and a waste heat tank with internal tank feed water preheating. A further usage scenario entails, upstream of a synthesis circuit, a “once-through reactor”, this being a radially flow-traversed three-bed converter with two internal heat exchangers, a tank feed water preheater with partial evaporation, disposed in the gas path before the gas is supplied to the synthesis circuit, which consists of a radially flow-traversed converter with two catalyst beds and an internal heat exchanger, a waste heat tank, a radially flow-traversed one-bed converter without internal heat exchanger, and a waste heat tank with internal tank feed water preheating. In this case, the once-through reactor can be operated at a lower pressure level than the other two reactors.

In a further configuration of the process of the invention, a hydrogen store is provided which is connected fluidically to the synthesis circuit, the master controller dictates the minimum opening of a seventh flow control valve as a function of the amount of hydrogen provided by the electrolysis, wherein the seventh flow control valve establishes the flow rate of the hydrogen from the hydrogen store into the synthesis circuit.

The control loops described above make it possible for the capacity of the ammonia plant to be lowered to 25% of the nominal production amount, with the circulation gas amount dropping only to 50% of the circulation gas amount at full production. This presupposes, however, that 25% of the hydrogen required for full production is fed into the synthesis gas circuit with the make-up gas. If hydrogen generation in the electrolyzer drops below 25%, the difference must be taken from the hydrogen store, in order to maintain minimum operation of the plant. For this purpose, a seventh flow control valve in the withdrawal line from the hydrogen store is used, and establishes the required hydrogen stream.

This control, however, need not be restricted only to the 25% running scenario of the ammonia plant. With hydrogen production by the electrolyzer of higher than 25% but lower than 100% as well, it can be utilized to operate the ammonia plant at a higher capacity than that of the electrolyzer for a limited time, and in so doing to provide optimal utilization of the available hydrogen store. This requires reliable prediction of the time profile of the available renewable fluctuating energy, which the master controller uses to determine a profile for withdrawal from the hydrogen store.

The object stated above is also achieved by a plant for producing ammonia in a synthesis circuit, having at least one conveying device for cyclically conveying a gas mixture comprising nitrogen, hydrogen and ammonia, having at least one converter, wherein nitrogen and hydrogen can be converted at least partly into ammonia in the converter, and having at least one cooling device in which the gas mixture can be cooled in such a way that ammonia condenses out of the gas mixture, wherein hydrogen can be provided at least partly by an electrolyzer and wherein at least one bypass line is provided to circumvent at least one unit of the synthesis circuit, wherein the flow rate in the bypass line can be established by at least one flow control valve, wherein a master controller is provided, wherein the at least one flow control valve can be regulated by the master controller. It is envisaged that a process of the invention can be carried out by the plant.

The object stated above is in particular also achieved by a plant for producing ammonia in a synthesis circuit, having at least one conveying device for cyclically conveying a gas mixture comprising nitrogen, hydrogen and ammonia, having at least one converter, wherein nitrogen and hydrogen can be converted at least partly into ammonia in the converter, and having at least one cooling device in which the gas mixture can be cooled in such a way that ammonia condenses out of the gas mixture, wherein the conveying device comprises a first suction side and a first pressure side. Additionally, a second bypass line is provided, wherein the gas mixture can be divided by the second bypass line into a first substream and a second substream and wherein the second bypass line forms a flow pathway upstream of the cooling device to a region upstream of the first suction side of the conveying device.

An impermissible increase in the exit temperature from a catalyst bed in the converter can be avoided by raising the NH3 content at the entry of the converter. The resultant maximum temperature at the exit from the catalyst bed or catalyst beds, the equilibrium temperature, is then lower and is within the permitted range. To accomplish this, a portion of the hot, reacted circulation gas is routed around the cooling device, which may for example comprise gas cooler, cold exchanger and/or loop chiller. The other portion of the gas is cooled in the cooling device to the unaltered condensation temperature of the ammonia. This first substream with a low ammonia content is thereafter mixed with the ammonia-rich bypass stream, the second substream, and supplied to the first suction side of the conveying device. The conveying device may for example comprise a compressor and/or a blower.

In a first configuration of the plant of the invention, the second bypass line comprises a bypass heat exchanger for cooling the second substream. It must be ensured that the entry temperature of the mixed stream into the conveying device is not too high, to prevent an impermissible high exit temperature from the compressor. For this purpose, a portion of the bypass stream is passed via a bypass heat exchanger and cooled. The mass flow rate is controlled as a function of the temperature of the mixed stream on the first suction side of the conveying device.

To allow the temperature to be established in a particularly precise manner, in a further configuration of the plant of the invention, a bypass bypass line is provided for circumventing the bypass heat exchanger.

In one advantageous configuration of the plant of the invention, the converter comprises a first catalyst bed, a second catalyst bed and a third catalyst bed.

To allow the reaction in the converter to be managed more efficiently, in a further configuration of the invention, the converter comprises at least two radially flow-traversable internal heat exchangers, and the first internal heat exchanger is disposed between the first and the second catalyst beds and the second internal heat exchanger is disposed between the second and the third catalyst beds.

Additionally or alternatively, in a further configuration of the plant of the invention, a device for generating steam is provided downstream of the converter.

The aforementioned object is also achieved by a process for retrofitting a plant for producing ammonia, having at least one conveying device for cyclically conveying a gas mixture comprising nitrogen, hydrogen and ammonia, having at least one converter, wherein nitrogen and hydrogen can be converted at least partly into ammonia in the converter, and having at least one cooling device in which the gas mixture can be cooled in such a way that ammonia condenses out of the gas mixture, wherein the conveying device comprises a first suction side and a first pressure side. For the retrofitting, a bypass line is introduced. By the bypass line, the gas mixture can be divided into a first substream and a second substream, wherein the bypass line forms a flow pathway upstream of the cooling device to a region upstream of the first suction side of the conveying device.

In one advantageous configuration of the invention, nitrogen is provided by means of an air separation plant.

The statements above relating to the process of the invention are also valid correspondingly for the plant of the invention for producing ammonia and for the process for retrofitting a plant for producing ammonia.

“A unit of the synthesis circuit” refers to the individual unit operations (basic operations of process engineering, such as condensing, evaporating, compressing, subjecting to chemical reactions, and the like) and to parts of the individual unit operations. A bypass line may be disposed for example, though not conclusively, around the conveying device, the converter, the cooling device, various compressors and/or heat exchangers.

In detail, there are a multiplicity of ways of configuring and developing the process of the invention and the plant of the invention. In this regard, reference is made not only to the claims subordinate to claims 1 and 11, but also to the description below of preferred exemplary embodiments in conjunction with the drawings. In the drawings,

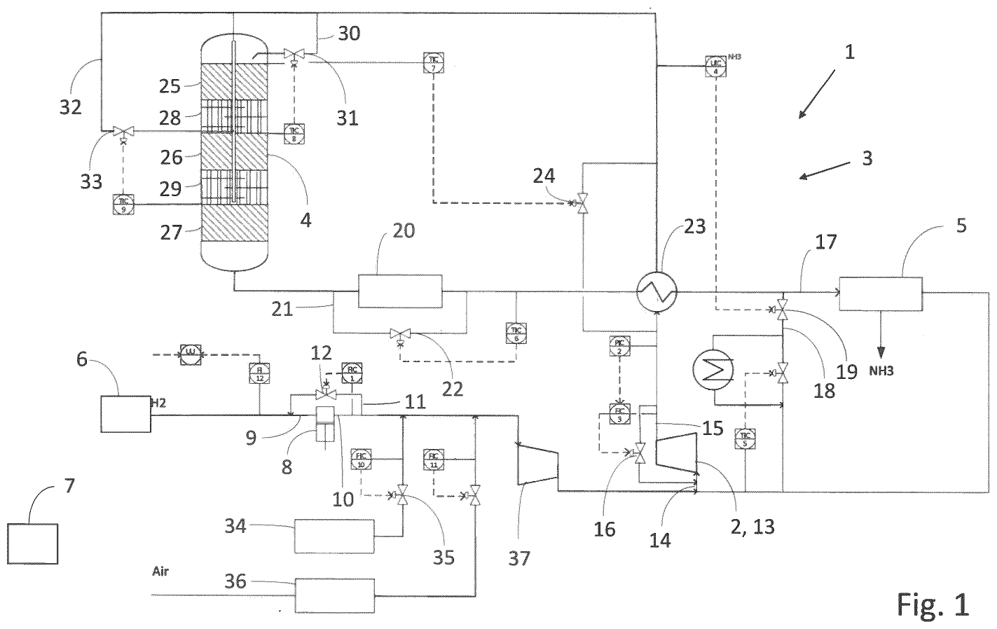

FIG. 1 shows a schematic representation of a plant for producing ammonia, having various control loops, according to a first example,

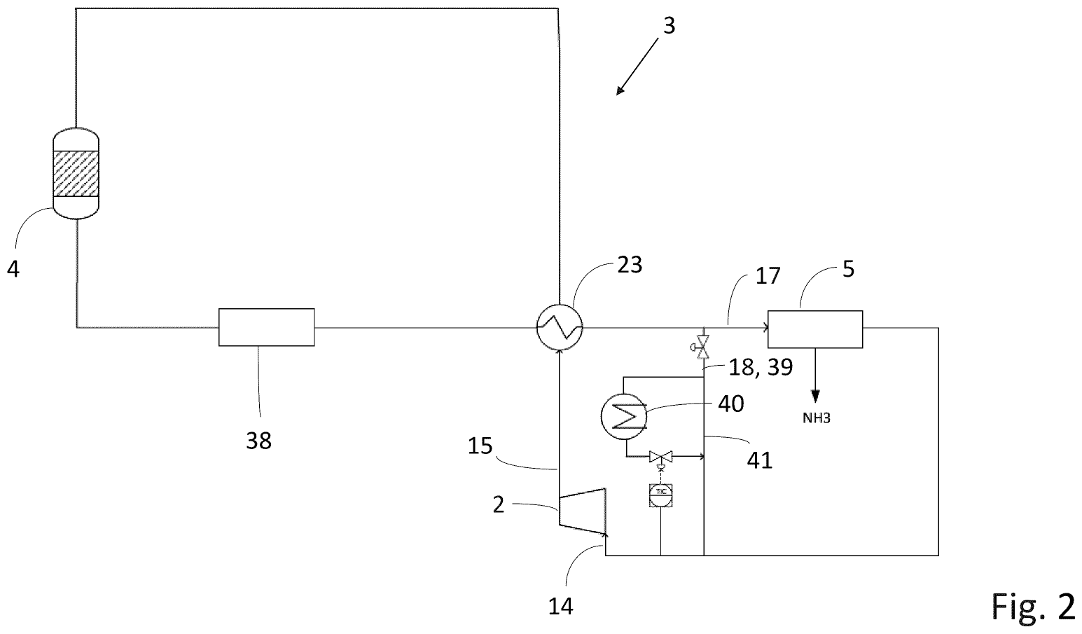

FIG. 2 shows a simplified schematic representation of a part of a plant for producing ammonia, having a bypass ahead of a cooling device, according to a second example,

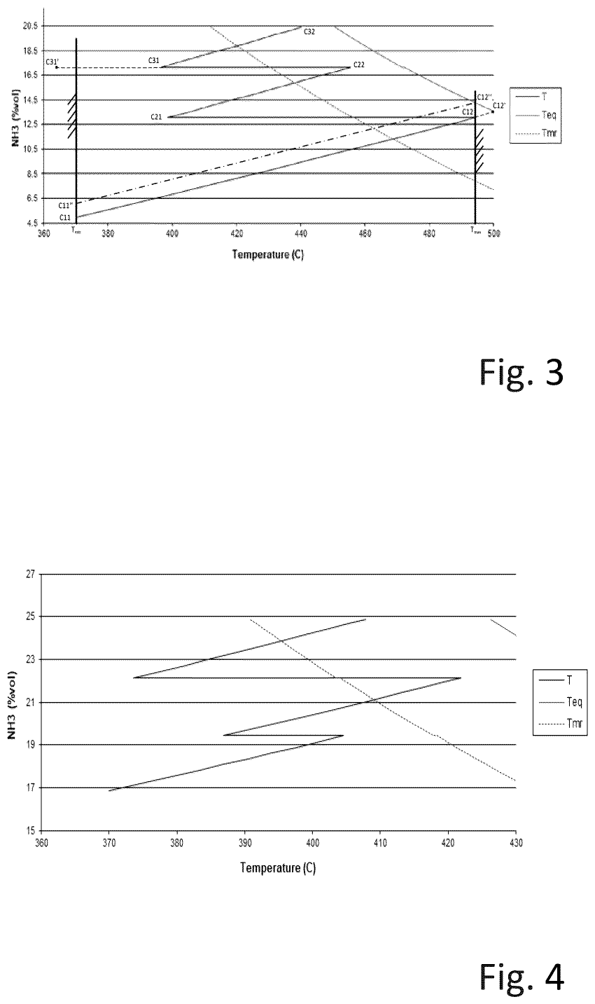

FIG. 3 shows a profile of concentration and temperature in the converter, as customary in the prior art, and

FIG. 4 shows a profile of concentration and temperature in the converter, in accordance with the present invention.

FIG. 1 shows a schematic representation of a part of an ammonia plant 1 having various control loops according to a first example. In the operation of the ammonia plant 1, a gas mixture comprising nitrogen (N2), hydrogen (H2) and ammonia (NH3) is conveyed cyclically in a synthesis circuit 3 by a conveying device 2. Nitrogen (N₂) and hydrogen (H2) are converted at least partly into ammonia (NH3) in a converter 4. The gas mixture is subsequently cooled in a cooling device 5 in such a way that ammonia (NH3) condenses out of the gas mixture. In the process, hydrogen is provided at least partly by electrolysis 6. Additionally provided is a master controller 7. On the basis of the anticipated amount of hydrogen, the master controller 7 keeps at least the pressure in the synthesis circuit 3 approximately constant via at least one control loop.

The electrolysis 6 is operated by means of renewable energies. Because of the fluctuating renewable energies, it is sometimes necessary to adapt the capacity of the electrolysis 6 according to the amount of energy currently available. Because of this, the ammonia plant can temporarily be run only in partial-load operation. For this purpose, the amount of hydrogen generated by the electrolysis 6 is measured at the entry into the ammonia plant 1. The master controller 7 adapts the capacity of the ammonia plant 1, taking account of the amount of hydrogen measured. In addition, the master controller 7 dictates setpoint values in various control loops, when the change in load to be established in the ammonia plant 1 is below a predetermined limiting value. When the change in load to be established is above a predetermined limiting value, the master controller 7 directly dictates the degree of opening of a control valve of the control loop.

The master controller 7 has a variety of control loops available, which it controls superordinately and in dependence on one another. Firstly, the hydrogen is compressed with at least one second compressor 8 having a second suction side 9 and a second pressure side 10. A third bypass line 11 is provided from the second pressure side 10 to the second suction side 9. Depending on the anticipated suction stream at the second suction side 9 of the second compressor 8, the master controller 7 dictates the minimum opening of a third flow control valve 12. The third flow control valve 12 establishes the flow rate in the third bypass line 11.

Furthermore, the conveying device 2 comprises a first compressor 13 having a first suction side 14 and a first pressure side 15. A first bypass line is provided from the first pressure side 15 to the first suction side 14. Here as well, depending on the anticipated first suction stream at the first suction side 14 of the first compressor 13, the master controller 7 is able to dictate the minimum opening of a first flow control valve 16. The flow rate in the first bypass line can be established by the first flow control valve 16.

In a further control loop, the gas mixture is divided ahead of the cooling device 5 into a first substream 17 and a second substream 18. The first substream 17 is passed through the cooling device 5, in which ammonia can condense. The second substream 18, as a bypass to the cooling device 5, is introduced back into the synthesis circuit 3 in a region upstream of the first suction side 14 of the first compressor 13 of the conveying device 2. The second substream 18 is additionally cooled before introduction into the synthesis circuit 3. The master controller 7 here dictates the minimum opening of a second flow control valve 19. The second flow control valve 19 establishes the flow rate of the second substream 18.

The heat released by the ammonia reaction is utilized for generating steam in a first heat exchanger 20. Here, a fourth bypass line 21 around the first heat exchanger 20 is provided. The master controller 7 dictates the minimum opening of a fourth flow control valve 22, wherein the fourth flow control valve 22 establishes the flow rate in the fourth bypass line 21.

To preheat the gas mixture in the synthesis circuit 3, a second heat exchanger 23 is utilized. Here, a fifth bypass line around the second heat exchanger 23 is provided. The master controller 7 dictates the minimum opening of a fifth flow control valve 24, as a function of the entry temperature to be established for the gas mixture into the converter 4, wherein the fifth flow control valve 24 establishes the flow rate in the fifth bypass line.

The converter 4 comprises three radially flow-traversable catalyst beds: a first catalyst bed 25, a second catalyst bed 26 and a third catalyst bed 27. Additionally, the converter comprises a first internal heat exchanger 28 and a second internal heat exchanger 29. The first internal heat exchanger 28 is disposed between the first catalyst bed 25 and the second catalyst bed 26. The second internal heat exchanger 29 is disposed between the second catalyst bed 26 and the third catalyst bed 27. In two further control loops, there is firstly a sixth bypass line 30 around the first internal heat exchanger 28 and the second internal heat exchanger 29 provided, wherein the master controller 7 dictates the minimum opening of a sixth flow control valve 31, wherein the sixth flow control valve 31 establishes the flow rate in the sixth bypass line 30. Secondly, a seventh bypass line 32 around the second internal heat exchanger 29 is provided. The master controller 7 dictates the minimum opening of a seventh flow control valve 33. The seventh flow control valve 33 establishes the flow rate in the seventh bypass line 32.

In addition, a hydrogen store 34 is provided, to accommodate possible fluctuations in output. The hydrogen store 34 is connected fluidically to the synthesis circuit 3. Depending on the amount of hydrogen provided by the electrolysis 6, the master controller 7 dictates the minimum opening of an eighth flow control valve 35. The eighth flow control valve 35 establishes the flow rate of the hydrogen from the hydrogen store 34 into the synthesis circuit 3.

The electrolysis 6, which is an alkaline electrolysis of water, provides hydrogen, which is pre-compressed in a second compressor 8. Nitrogen is removed from air in an air separation plant 36 and is mixed with the compressed hydrogen. In a synthesis gas compressor 37, the synthesis gas is compressed further to the pressure of the synthesis circuit 3 and is mixed with the circulation gas on the second suction side 9 of the second compressor 8 of the conveying device 2, before being compressed to reaction pressure by the second compressor 8.

Before it enters the converter 4, the circulation gas enriched with hydrogen and nitrogen is preheated by the hot circulation gas in the first heat exchanger 20, in the form of a gas/gas heat exchanger. The converter 4 comprises the three catalyst beds 25, 26 and 27 and the two heat exchangers 28 and 29. The preheated circulation gas enters the second internal heat exchanger 29 through an interior tube, and in heat exchanger 29 it is preheated further on the tube side by the hot exit gas from the second catalyst bed 26, which is flowing on the shell side. It then flows on to the first internal heat exchanger 28, where it is preheated to the catalyst light-off temperature by the hot exit gas from the first catalyst bed 25. The gas then enters into the first catalyst bed 25, where hydrogen and nitrogen undergo exothermic reaction to form ammonia to a point close to the chemical equilibrium.

The hot reaction gas flows thereafter on the shell side through the first internal heat exchanger 28, where it is cooled by the circulation gas that requires heating, and so the reaction is able to progress further. In the second and third catalyst beds 26 and 27 and in the second internal heat exchanger 29, this procedure is repeated. The reaction gas has a sufficiently high temperature to generate superheated steam in a steam generation and to preheat the cold circulation gas in the second heat exchanger 23, in the form of a gas/gas heat exchanger. The ammonia-rich circulation gas is then cooled further to the condensation temperature of ammonia in the cooling device 5. The ammonia formed is removed from the circulation in liquid form. Thereafter, the gas is mixed with the fresh gas and conveyed in circulation by the conveying device 2 back to the converter 4.

FIG. 2 shows a schematic representation of a part of an ammonia plant according to a second example. In the operation of the ammonia plant, a gas mixture comprising nitrogen (N2), hydrogen (H2) and ammonia (NH3) is conveyed cyclically in a synthesis circuit 3 by a conveying device 2. Nitrogen (N2) and hydrogen (H2) are converted at least partly into ammonia (NH3) in a converter 4. The gas mixture is subsequently cooled in a cooling device 5 in such a way that ammonia (NH3) condenses out of the gas mixture. In this process, hydrogen is provided at least partly by electrolysis. The conveying device 2 has a first suction side 14 and a first pressure side 15 (a first bypass line has been omitted in FIG. 2). The gas mixture is divided upstream of the cooling device 5 into a first substream 17 and a second substream 18. The first substream 17 is subsequently passed through the cooling device 5, and the second substream 18 is introduced back into the synthesis circuit 3, by means of a second bypass line 39, in a region upstream of the first suction side 14 of the conveying device 2.

In the plant under consideration here, the ammonia reaction takes place with catalysis in a converter 4 having three radially flow-traversed catalyst beds and two internal heat exchangers (not represented here). Heat exchange between the two catalyst beds means that the exothermic ammonia reaction is able to progress further, from bed to bed, and the cold circulation gas is preheated to the catalyst light-off temperature. The hot reaction gas leaves the converter 4 at a temperature of around 410° C. and with an ammonia content of 24.9 vol %, and is used to generate steam. In the gas/gas heat exchanger 23, it heats the cooled circulation gas. The gas is divided thereafter into the first substream 17 and the second substream 18. The ratio of the two streams to one another is preferably 36:64. The first substream is cooled to 0.4 degrees Celsius in the cooling device 5, and the condensed ammonia is removed. The ammonia concentration, at 4.9 vol %, is now much lower than that of the second substream 18. The second substream 18 is guided past the cooling device 5 to the first suction side 14 of the conveying device 2.

It is, though, necessary to ensure that the intake temperature of the conveying device 2 is not too high, so that the conveying device 2—a compressor, for example—is not damaged. For this purpose, a portion of the bypass stream is passed via a bypass heat exchanger 40 (which is likewise represented in FIG. 1 but has no reference signs). A further portion of the stream can be guided past the bypass heat exchanger 40 via a bypass bypass line 41. The amount of this substream is adjusted via a temperature regulator to 48 degrees Celsius entry temperature into the conveying device 2. The ammonia-rich second substream 18 and the cooled first substream 17 of low ammonia content are mixed again on the first suction side 14, with the desired ammonia entry concentration of 16.9 vol % into the converter 4 being established. The conveying device 2 conveys the mixed stream into the converter 4. Additionally provided in FIG. 2 is a device 38 for generating steam, which generates steam by the hot reaction gas after exit from the converter 4 (this device may have a structural embodiment similar to that of the heat exchanger represented in FIG. 1 or different therefrom).

FIG. 3 shows, illustratively, the temperature profile through three catalyst beds, as customary in the prior art. In this arrangement, the temperature and NH3 concentration increase in the catalyst beds (first catalyst bed: C11-C12, second catalyst bed: 2 C21-C22 and third catalyst bed: C31-C32). The internal heat exchangers are disposed between the first and second catalyst beds and between the second and third catalyst beds, and so the temperature, for constant ammonia concentration, falls again (first internal heat exchanger: C12-C21, second internal heat exchanger: C22-C31) and the exothermic reaction can proceed further.

Under partial load conditions in the plant for producing ammonia, the behavior of the system changes generally as follows, in the absence of intervention:
In the catalyst beds, the residence time of the gas increases. As a result, the components undergo reaction to closer to the equilibrium; in the diagram, the points C12, C22 and C32 shift in the direction of the equilibrium curve. This is indicated for the first catalyst bed by the shift of the point C12 to C12′.
In the internal heat exchangers, the exit temperature conforms to the temperature of the medium on the other side. This is indicated for the second heat exchanger by shifting of the point C31 through C31′.

If a temperature at the converter 4 leaves a defined range, this change signifies not a gradual difference, but rather a complete change in the behavior of the system:
For point C12, there is a maximum temperature (around 500° C.) which must not be exceeded. If it is exceeded, a consequence is that the steel in the NH3 atmosphere undergoes nitration (nitridation) and becomes brittle. As a consequence of this, the lifetime is shortened—this must be avoided.
Points C11, C21 and C31 must not fall below the so-called light-off temperature of the catalyst. Beneath the light-off temperature (around 370° C.), the reaction does not take place. If the temperature does fall below this value (because there is less heat of reaction available for heating the circulation gas/the reactants), the reaction stops and there is no assurance of it ensuing again with a rising amount of feedstock gas.

Where the amount of feedstock gas or of hydrogen is relatively small, there is a risk of the reaction proceeding further in the first catalyst bed, with a lower circulation quantity. This harbors the risk identified under the first point above, and feedstock gas which normally reacts only in the second catalyst bed is already being consumed. This would cause the second catalyst bed to cool. Owing to a longer residence time, the gas cools below the light-off temperature for the third catalyst bed in the second heat exchanger as well.

FIG. 4 shows a profile of concentration and temperature in the converter according to the present invention. The objective is to approximately maintain the temperature and concentration profile from above even with a smaller amount of gas. This requires that the reaction is maintained in all the catalyst beds. Here, for a smaller amount of H2 available, the amount is to be restricted in the same degree to the amount of ammonia formed. This allows the reaction to be maintained in all the catalyst beds. Because of the longer residence times in catalyst beds and heat exchangers, however, there are resulting differences:
The increase in the temperature C22 can be avoided by raising the entry NH3 content into the converter. This leads to a shifting of the points C11-C12 to C11′-C12′ into a region in which C12′ is below the permissible maximum temperature. For this, the NH3 content for C11′ must be chosen at a level such that the point C12′, whose highest NH3 concentration is limited by the line EQ, does not exceed the maximum allowed temperature.

The higher content of ammonia at the converter entry can be achieved in a variety of ways. Firstly, the condensation temperature of the ammonia can be raised. With increasing temperature, there is an increase in the saturation partial vapor pressure of the ammonia in the circulation gas and hence also in the concentration of the ammonia at the converter entry. This may be established by a higher pressure in the loop chillers in the cooling device 5 that are cooled with evaporating ammonia. The cooling device would then run in partial load. However, this would have the disadvantage that the temperature level in the loop chillers would change and these large steel masses of the apparatuses would heat up. If the full amount of synthesis gas was then available again, the cooling device 5 would first have to cool down these apparatuses again. In this time, the ammonia would be removed at a higher temperature and the entry concentration at the entry to the converter 4 would be too high, meaning that the converter is unable to achieve the conversion necessary for 100 percent output of the plant.

This problem can be circumvented in accordance with the invention by routing a portion of the hot reacted gas around the cooling device 5, through the second bypass line 39. The other portion of the gas is cooled to the unaltered condensation temperature of the ammonia in the cooling device. It is thereafter mixed with the second substream 18 and supplied to the first suction side 14 of the conveying device.

The resultant profile of concentration and temperature in the converter 4 is represented in FIG. 4. As is evident from FIG. 4, because of the high ammonia content at the entry to the converter 4, the exit temperatures from the catalyst beds are substantially lower. Nor is the temperature at the exit from the second heat exchanger below the catalyst light-off temperature. The resultant amount of circulation gas amounts to 50 percent of the amount of circulation gas at 100 percent plant output. Together with the reduced increase in ammonia concentration in the converter, a turn-down ratio of 25 percent is achievable in this way.

### LIST OF REFERENCE SIGNS

(1) ammonia plant
(2) conveying device
(3) synthesis circuit
(4) converter
(5) cooling device
(6) electrolysis
(7) master controller
(8) second compressor
(9) second suction side
(10) second pressure side
(11) third bypass line
(12) third flow control valve
(13) first compressor
(14) first suction side
(15) first pressure side
(16) first flow control valve
(17) first substream
(18) second substream
(19) second flow control valve
(20) first heat exchanger
(21) fourth bypass line
(22) fourth flow control valve
(23) second heat exchanger
(24) fifth flow control valve
(25) first catalyst bed
(26) second catalyst bed
(27) third catalyst bed
(28) first internal heat exchanger
(29) second internal heat exchanger
(30) sixth bypass line
(31) sixth flow control valve
(32) seventh bypass line
(33) seventh flow control valve
(34) hydrogen store
(35) eighth flow control valve
(36) air separation plant
(37) synthesis gas compressor
(38) device for generating steam
(39) second bypass line
(40) bypass heat exchanger
(41) bypass bypass line

1-16. (canceled)

17. A process for operating an ammonia plant, comprising:
conveying a gas mixture, comprising nitrogen (N2), hydrogen (H2), and ammonia (NH3), cyclically in a synthesis circuit with a conveying device, wherein the conveying device comprises at least a first compressor having a first suction side and a first pressure side, wherein a first bypass line is provided from the first pressure side to the first suction side,
converting nitrogen (N2) and hydrogen (H2) at least partly into ammonia (NH3) in a converter,
cooling the gas mixture in a cooling device in such a way that ammonia (NH3) condenses out of the gas mixture,
providing hydrogen at least partly by electrolysis,
keeping at least a pressure in the synthesis circuit approximately constant, by a master controller, via at least one control loop on the basis of an anticipated amount of hydrogen,
dictating, by the master controller, a minimum opening of a first flow control valve as a function of an anticipated first suction stream at the first suction side of the first compressor, wherein the first flow control valve establishes at least a flow rate in the first bypass line, and
dividing the gas mixture upstream of the cooling device into a first substream and a second substream, wherein the first substream is passed through the cooling device, wherein the second substream is introduced back into the synthesis circuit in a region upstream of the first suction side of the first compressor of the conveying device, and wherein the second substream is cooled before introduction into the synthesis circuit, wherein the master controller dictates the minimum opening of a second flow control valve, wherein the second flow control valve establishes at least a flow rate of the second substream.

18. The process as claimed in claim 17, wherein an amount of hydrogen generated by the electrolysis is measured at the entry into the ammonia plant and wherein the master controller adapts the capacity of the ammonia plant, taking account of the amount of hydrogen measured.

19. The process as claimed in claim 17, wherein the master controller dictates setpoint values to control elements of the at least one control loop if a change in load to be established is below a predetermined limiting value, and wherein the master controller directly dictates the degree of opening of a control valve of the control loop if the change in load to be established is above a predetermined limiting value.

20. The process as claimed in claim 17, wherein the second substream is cooled before introduction into the synthesis circuit.

21. The process as claimed in claim 17, wherein the hydrogen is compressed with at least one second compressor having a second suction side and a second pressure side, wherein a second bypass line is provided from the second pressure side to the second suction side and wherein the master controller dictates a minimum opening of a third flow control valve as a function of an anticipated second suction stream at the second suction side of the second compressor, wherein the third flow control valve establishes at least a flow rate in the second bypass line.

22. The process as claimed in claim 17, wherein heat released from converting nitrogen (N2) and hydrogen (H2) at least partly into ammonia (NH3) in a converter is utilized for generating steam in at least one first heat exchanger, wherein a second bypass line around the first heat exchanger is provided and wherein the master controller dictates a minimum opening of a third flow control valve, wherein the third flow control valve establishes at least a flow rate in the second bypass line.

23. The process as claimed in claim 17, wherein at least a second heat exchanger is utilized for preheating the gas mixture in the synthesis circuit, wherein a second bypass line around the second heat exchanger is provided and wherein the master controller dictates a minimum opening of a third flow control valve as a function of an entry temperature to be established for the gas mixture into the converter, wherein the third flow control valve establishes at least a flow rate in the second bypass line.

24. The process as claimed in claim 17, wherein the converter comprises a first radially flow-traversable catalyst bed, a second radially flow-traversable catalyst bed and a third radially flow-traversable catalyst bed, wherein the converter comprises at least first and second internal heat exchangers and wherein the first internal heat exchanger is disposed between the first catalyst bed and the second catalyst bed and wherein the second internal heat exchanger is disposed between the second catalyst bed and the third catalyst bed, wherein a second bypass line around the first internal heat exchanger is provided and wherein the master controller dictates a minimum opening of a third flow control valve, wherein the third flow control valve establishes at least a flow rate in the second bypass line.

25. The process as claimed in claim 24, wherein a third bypass line around the second internal heat exchanger is provided and wherein the master controller dictates a minimum opening of a fourth flow control valve, wherein the fourth flow control valve establishes at least a flow rate in the third bypass line.

26. The process as claimed in claim 17, wherein a hydrogen store is provided which is connected fluidically to the synthesis circuit, wherein the master controller dictates a minimum opening of an third flow control valve as a function of the amount of hydrogen provided by the electrolysis, wherein the third flow control valve establishes a flow rate of the hydrogen from the hydrogen store into the synthesis circuit.

27. A plant for producing ammonia (NH3) in a synthesis circuit, comprising:
at least one conveying device for cyclically conveying a gas mixture comprising nitrogen (N2), hydrogen (H2), and ammonia (NH3),
at least one converter, wherein nitrogen (N2) and hydrogen (H2) can be converted at least partly into ammonia (NH3) in the converter, and
at least one cooling device in which the gas mixture can be cooled in such a way that ammonia (NH3) condenses out of the gas mixture,
wherein hydrogen can be provided at least partly by an electrolyzer,
wherein at least one bypass line is provided to circumvent at least one unit of the synthesis circuit,
wherein a flow rate in the bypass line can be established by at least one flow control valve,
wherein a master controller is provided, wherein the at least one flow control valve can be regulated by the master controller.

28. The plant as claimed in claim 27, wherein the conveying device comprises a first suction side and a first pressure side, wherein a second bypass line is provided, wherein the gas mixture can be divided by the second bypass line into a first substream and a second substream and wherein the second bypass line forms a flow pathway upstream of the cooling device to a region upstream of the first suction side of the conveying device.

29. The plant as claimed in claim 28, wherein the second bypass line comprises a bypass heat exchanger for cooling the second substream, wherein, in addition to the bypass heat exchanger of the second bypass line, a bypass bypass line is provided for circumventing the bypass heat exchanger.

30. The plant as claimed in claim 28, wherein the converter comprises a first catalyst bed, a second catalyst bed, and a third catalyst bed, and the converter comprises at least one or more radially flow-traversable heat exchangers, wherein the first heat exchanger is disposed between the first and the second catalyst beds and the second heat exchanger is disposed between the second and the third catalyst beds.

31. The plant as claimed in claim 28, wherein a device for generating steam is provided downstream of the converter.

32. A process for retrofitting a plant for producing ammonia, having at least one conveying device for cyclically conveying a gas mixture comprising nitrogen (N2), hydrogen (H2) and ammonia (NH3), having at least one converter, wherein nitrogen (N2) and hydrogen (H2) can be converted at least partly into ammonia (NH3) in the converter, and having at least one cooling device in which the gas mixture can be cooled in such a way that ammonia (NH3) condenses out of the gas mixture, wherein the conveying device comprises a first suction side and a first pressure side, the process comprising:
providing a bypass line by which the gas mixture can be divided into a first substream and a second substream, wherein the bypass line forms a flow pathway upstream of the cooling device to a region upstream of the first suction side of the conveying device.
